(19) United States
(12) Patent Application Publication
(10) Pub. No.: US 2012/0101932 A1
(43) Pub. Date: Apr. 26, 2012

(54) AUTOMATION OF ENERGY TRADING

(75) Inventors: Ilya Slutsker, Plymouth, MN (US); Yulius Nicolaus, Plymouth, MN (US); Scott Arcand, St. Louis Park, MN (US); Sasan Mokhtari, Eden Prairie, MN (US); Behnam Danai, Cupertino, CA (US)

(73) Assignee: OPEN ACCESS TECHNOLOGY INTERNATIONAL, Minneapolis, MN (US)

(21) Appl. No.: 13/140,248

(22) PCT Filed: Dec. 15, 2009
(86) PCT No.: PCT/US09/68077

§ 371 Date: Dec. 30, 2011

Related U.S. Application Data
(60) Provisional application No. 61/138,027, filed on Dec. 16, 2008.

(51) Int. Cl. G06Q 40/04

(52) U.S. Cl. 705/37

(57) ABSTRACT

A computer program for automating energy trading between regional transmission organizations (RTOs) is disclosed. The computer program includes computer readable program code means for creating a template for an energy trade between two RTOs, wherein the template comprises a plurality of trade components, the plurality of trade components being arranged in sequential order according to an RTO's required order of execution; computer readable program code means for selecting a template for an energy trade between two RTOs; computer readable program code means for displaying a summary of a trade; and computer readable program code means for monitoring and displaying a trade's status.

### CROSS-REFERENCE TO RELATED APPLICATIONS

This application is a National Stage entry from PCT/US09/68077 filed Dec. 15, 2009, which claims priority Provisional Patent Application Ser. No. 61/138,027, filed Dec. 16, 2008, the entire contents of which are hereby incorporated by reference.

### STATEMENT REGARDING FEDERALLY SPONSORED RESEARCH

Not Applicable

### FIELD OF THE INVENTION

The present invention relates generally to energy trading between Regional Transmission Organizations (RTO), and in particular to software that simplifies procurement of energy in one RTO market and its resale in another.

### BACKGROUND OF THE INVENTION

An inter-RTO Trade (or RTO Trade, as it will be referred to in this document) is a coordinated purchase of power in one RTO market and sale in another. Due to RTO-specific requirements, an RTO trade may contain a number of components and include a number of inter-dependent steps that currently require a manual creation of various market objects in various systems in a defined order. The relatively high overhead of these actions places a high burden on scheduling personnel. As such, there is a need for a fully automated and configurable trade process that takes a user out of the loop.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All U.S. patents and applications and all other published documents mentioned anywhere in this application are incorporated herein by reference in their entirety.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided for the purposes of complying with 37 C.F.R. §1.72.

### BRIEF SUMMARY OF THE INVENTION

In at least one embodiment, the invention is directed to a computer program product for use with a graphics display device, the computer program product comprising a computer usable medium having computer readable program code means embodied in the medium for automating energy trading between Regional Transmission Organizations (RTOs). The computer program product comprises computer readable program code means for creating a template for an energy trade between a first RTO and a second RTO, wherein the template comprises a plurality of trade components, the plurality of trade components being arranged in sequential order according to the first RTO and the second RTO's required order of execution; computer readable program code means for selecting a template for an energy trade between two RTOs; computer readable program code means for displaying a summary of a trade; and computer readable program code means for monitoring and displaying a trade's status.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWINGS

The present invention will be explained in more detail below by means of drawings.

FIG. 1 shows a block diagram of the RTO trading system.

FIG. 2 shows block diagram of a webAgent trade.

FIG. 3 shows a block diagram of the various RTO's between which trades may be made.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

Reference is made throughout to the attached Appendices 1-21, listed on the Table of Contents, the entire contents of each being incorporated herein by reference.

Energy trading between Regional Transmission Organizations (RTOs) currently involves multiple manual operations in a number of different systems, requiring that data be re-entered in the different systems. This system is time-consuming and error prone. The following is an example of at least some steps needed to buy power in the PJM Interconnection and move it to NYISO using the current system:
Submit RT Ramp Reservation to PJM portal
Confirm that PJM Ramp Reservation has been granted
Create delayed Tag (referencing ramp ID)
Create and submit NYISO DAM Transaction to NYISO portal
Wait for and detect NYISO DAM clearing
If Fully Cleared in NYISO DAM:
   Submit request to buy transmission in PJM OASIS
   Confirm that OASIS reservation has been approved
   Create and submit PJM Two Settlement transaction to PJM portal
   Add OASIS number to delayed tag and activate it by submitting to E-tag system
If Partially Cleared in NYISO DAM:
   Submit RT Ramp Reservation Adjustment to PJM portal
   Confirm that PJM Ramp Reservation Adjustment has been approved
   Submit request to buy transmission in PJM OASIS using adjusted MW profile
   Confirm that OASIS reservation has been approved
   Create and submit PJM Two Settlement transaction to PJM portal
   Add OASIS number, modify MW profile and activate delayed tag by submitting to E-tag system
If Not Cleared in NYISO DAM:
   Terminate trade and inform users
      As can be seen from the above example, there are multiple manual actions in different systems, including the NYISO portal, the PJM portal, OASIS, and E-Tag.

Embodiments of the present invention, referred to hereinafter as “webAgent” remove the complexity of these trades. For example, users enter a minimal amount of data on single display. Users are informed in real time about status of their trades. All created objects (transactions, reservations, tags, schedules) are available in a tool referred to hereinafter as “webTrader.” Other advantages are detailed in Appendix 1.

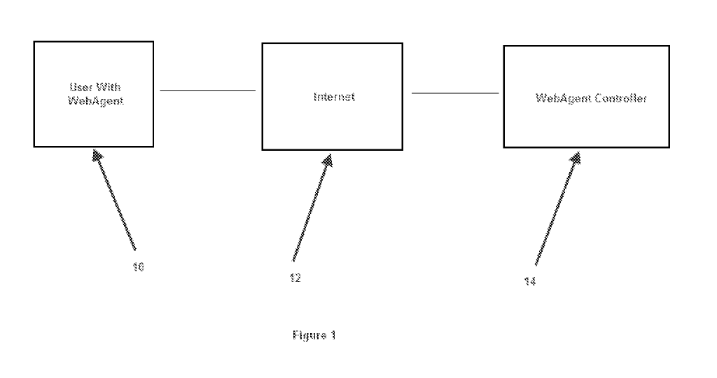

Referring again to Appendix 1, FIG. 1 on slide 13 shows a graphical representation of the webAgent trade concept. webAgent is unique for a number of reasons, including the following:
Execution steps are organized in sequences.
Sequences can be configured without programming for various market pairs to meet specific customer needs.
Trade combines execution sequence and data fields and contains all necessary information to move power between markets.
Trade steps create objects (schedules, tags, reservations).
Object data is controlled by Trades and Templates.
Created objects are captured in webTrader.
Templates provide shortcut for trade entry.

With respect to the trade steps, the steps are building blocks that define unique units of work. One embodiment of a screen display showing execution steps is depicted in Appendix 1, slide 21. Slide 22 of Appendix 1 depicts a screen display of an execution step entry page.

Sequences combine the steps together in coherent work patterns along with internal execution routing (what-if-then logic) and the data profile required to support step activities. One embodiment of a trade sequence entry page is shown in Appendix 1, slide 23. Each sequence encodes all of a trade's characteristics as far as its data needs, execution logic, and interaction with users are concerned. No information other than sequence is needed by webAgent to perform the following trade related activities:
Select correct template for given trade type (an example of a template shown in Appendix 1, slide 24)
Request minimally required data entry from users for given trade type, as seen in Appendix 1, slide 25)
Allow users to reconfigure trade on the fly
Allow users to pause/resume trade execution
Execute trade and deal with various what-if situations and outcomes
Inform users based on situation severity
   webAgent also allows trades to be monitored, and provides a summary of trades, as depicted in Appendix 1, slide 26.

The four concepts in webAgent are RTO Trade, Trade Component, Trade Step, and Trade Sequence. RTO trade is a virtual container of all objects that are required to facilitate the purchase of energy in one RTO market and its subsequent sale in another.

A trade component is an object that is recognized in and required by a specific market to perform or support a trading function, such as a bid, ramp reservation, tag, bilateral transaction, etc. A trade step is a unit of execution of a given object that changes its state. Creation, submission, and confirmation are steps most frequently used for webAgent objects. A trade sequence is an aggregation of trade steps into a coherent group that fully implements the desired trade. The trade sequence includes the rules that govern the interactivity between the individual trade steps. webAgent trade components and steps are summarized in Table 1 of Appendix 2, pages 1-2.

The system will display the status of each step as well as the overall trade status in near real time to keep users informed about the current condition of each trade. The statuses used in webAgent are shown in Table 2 of Appendix 2, pages 2-3.

webAgent will be a persistent software component with the enhanced survivability level. It will be implemented as a continuously executing SQL job that will be restarted with a one minute granularity to ensure minimum interruptions in cases of software failures.

At the point of initiation, webAgent will query the trade sequence description, define records for all execution steps (i.e. construct a trade plan) and will continuously track the status of each step, scheduling their execution in the dependency order based on their readiness. Most of processing steps will be executed by the webAgent itself. All confirmation steps will require external action from a foreign system (i.e. portal, Tagging, OASIS) to change the status of an appropriate step in the RTO trade. In addition, the statuses of certain steps can be manually changed by users as a result of the replacement action (see below). Such changes will be quickly detected by webAgent and the affected step will be immediately executed.

webAgent will be continuously scanning all open steps of all RTO trades residing in the execution queue. It will identify steps that can be processed. Once any step or a group of steps have been selected for processing, webAgent will schedule them asynchronously. The scheduled steps will, therefore, be executed in parallel optimizing the webAgent's performance.

webAgent will create a trade plan (i.e. a composition of trade steps) at the point of trade entry into the system. webAgent will determine based on timing rules when a trade needs to be started and will initiate its execution at the earliest possible time.

Once the execution has commenced, webAgent will execute each step as soon as it become eligible. When constructing the market message for a given step, webAgent will use the data sources already defined for an RTO Trade, as described in the next section. No data outside of these data sources will be used.

Users can stop/re-start webAgent execution at any point. Users can enable/disable any step within a trade. Users can replace the existing or associate new components with an RTO Trade. The replacement action means that an object previously created by webAgent is replaced with another one manually created by users in webTrader. The ID of a new object will be used in dependent objects and all downstream steps dependent on the replaced object will be activated. The replacement action may be useful in case when a trade component failed in the market and need to be manually repaired, which will enable webAgent to continue the RTO trade automation. The replacement action will be supported for PJM ramp and NERC tag objects.

The association of the object with an RTO trade simply links the object manually created in webTrader to a trade. In the current webAgent implementation, additional NERC tags, PJM ramp reservations and NYISO HAM transaction can be associated with an RTO trade.

For manually entered objects, users are responsible for making sure that replaced or associated objects are consistent with RTO trade profile and parameters. webAgent will terminate an RTO trade when any step aborts. Users are expected to manually complete the remaining steps or overwrite the failed step via a replacement action, provided that it is supported, and request that webAgent resumes the RTO trade execution.

webAgent will provide a log of all actions and events. The log can be filtered by trade, component, step and status, for example.

Examples of execution logic for trade between RTOs are shown in Appendix 2, pages 5-18.

Turning now to the controller, the controller is the brain of webAgent. The controller interprets trade sequences at any point in the trade lifecycle and takes appropriate action—for example, scheduling, data entry, notification, etc. The controller runs many trades in parallel at different stages in their lifespan. The controller is a persistent queue managing process. The controller simultaneously dispatches and manages execution of many steps in many trades in accordance with trade configuration as defined in respective trade sequences. User requests and step responses are placed in webAgent queue. The webAgent controller continuously scans the queue looking for processes that need to be executed. When any action is completed, the controller queries trade's sequence definition to find what, if anything, needs to be done next. Users can start/stop execution by issuing requests to the webAgent controller. All processes that need to be executed are scheduled asynchronously in separate threads to improve the system throughput. Even processes that do not return results are continuously monitored by the controller. Each queue entry has two timeout settings, for warning and abort conditions. If no response is received from step's module within the warning interval, the controller will take an action as configured in the sequence (i.e. notify a user). If no response is received within the abort timeout, a step will be declared aborted by the controller and an appropriate pre-defined action will be taken.

Referring again to webTrader, the inter-RTO trading facilities will be developed in webTrader to provide an advanced level of automation and supplement the already existing RTO interface tools. webTrader will provide an RTO trade object, a single container that groups the otherwise scattered financial (day ahead transactions, two settlement trades) and physical (OASIS reservations, NERC tags) objects created in various systems (RTO portals, OASIS, E-tag) to support a single trade that involves the procurement of energy in one RTO market and its resale in another. Each market pair has unique implementation requirements driven by the specifics of the source and target RTOs. webTrader allows users to select the type of the RTO trade they wish to implement, enter a minimal amount of information, and submit the trade for implementation with a single button click.

The webAgent technology will be utilized in webTrader to implement an RTO trade on behalf of users. webAgent will submit each component of a trade (i.e. ramp reservation, tag, etc.) to an appropriate external system in compliance with the RTO market rules and timing requirements. It will monitor the component's progress and inform users in real time about its current status and final outcome. Once one component has been processed, webAgent will automatically submit the next trade piece in the dependency chain and will proceed, in turn, to monitor its progress.

The RTO Trader Monitor display will provide a real time view of the trade's progress. An example of the RTO Trade Monitor is seen in an example of which is seen in Appendix 3, page 7. It will employ colored status indicators to facilitate quick, at-a-glance detection of any issues that require user intervention, such as a tag denial, OASIS procurement issues, unfavorable market clearing outcome, data transmission problems, market validation errors, etc. Under most circumstances, no user engagement will be needed. webAgent will initiate and automatically complete requested RTO trades by submitting and tracking all components of such trades—ramp reservation, two settlement transactions, physical transaction, OASIS reservations, and NERC tags.

The component status shown on the RTO Trader Monitor can be Waiting, Working, Completed, Error, and Disabled, for example. The global status will also be provided for each trade. It will indicate whether a trade has been saved but not submitted to markets, or, if it has been submitted whether it is currently active, inactive, or in error.

The RTO Trader Monitor will allow users to switch from the automatic to manual mode for selected trades to resolve issues or make desired changes. It will present all RTO trades that met filtering criteria for a single selected operating day.

The RTO Trade Viewer can be invoked from the RTO Trader Monitor display for a specific RTO trade to view its details as well as alter and manage its components for a single selected operating date.

webAgent will automatically create matching webTrader objects for all trade components and display them on appropriate summaries. All data will be immediately available for settlement processing and P&L analysis.

Users will create new RTO Trades on the RTO Trade Entry display, an example of which is seen in Appendix XXX, FIG. XXX. All trade parameters required to create trade components (OASIS reservations, ramp reservations, transactions, tags, etc.) will be stored as a template in the system and used at the trade creation time transparently to users. The only data users are expected to enter would be MW and price profiles and perhaps few other market specific indicators, such as, for instance, whether a two settlement transaction component needs to be created in a given RTO trade.

The RTO Trade Template display will be provided to enable users to create trade profiles and speed up the trade creation. While it is expected that a single template will be sufficient for most market trades, additional templates can be created as needed. An example of a Trade Template entry form is seen in Appendix 2, page 4 and an example of a Trade Template Summary is seen in Appendix 2, page 5.

The RTO Trade Entry display will be used to enter one or more RTO Trades into webTrader using a pre-defined template for the selected pair of source and target RTO markets. Trades can be entered for a date range using a single 24-hour profile for each day Similar to other webTrader objects, RTO trades can be either saved in the system for later submission to the market upon user's request or submitted immediately at the point of creation.

Once an RTO trade has been submitted to both markets, RTO Trade View display can be used to observe and manage the trade components for a selected date. Users can perform manual actions to replace or complement webAgent actions, such as assigning a new delayed tag to a transaction or initiating the creation of a NYISO hour ahead transaction (for both PJM-NYSIO and NYISO-ISONE trade types) and the corresponding new PJM ramp reservation.

An example of a market pair and their trade components supported in the RTO Trading Module is seen in Appendix 4, pages 3-4.

The present invention further includes a Trade Simulator, printouts of which are shown in Appendix 3, pages 9-10. The basic concept of the simulator will be to create messages to send to webTrader. The messages will be in the same format as the market message and can therefore be sent directly to the webTrader subcalls that are used to process the market messages. The webTrader subcalls will need to be modified to submit messages to expect responses from the simulator—this will be controlled by a system-wide switch.

The switch will be turned on and off by the simulator—when the simulation begins, the switch will be set to on and remain on until the simulation ends. If the switch is turned on and the source of the message is RTOTradeSimulator, the submission to market will be skipped and the subcall will expect a response message from the simulator. The simulator will contain a subcall that can be called in order to generate and return the expected result in this case.

Simulations will be set up by RTO Trade ID. This ID, to be defined as the ID of the RTO Trade itself, will relate a trade to a specific scenario. A scenario will be a set of outcomes to be simulated for an RTO Trade. When the simulator is turned on and a trade with the same ID as a simulator scenario exists, the simulator will provide the market responses to the webTrader subcalls.

Two new displays are used by the simulator. The first is the RTO Trade Simulator Scenario Summary. This display is a summary of all existing simulation scenarios. The primary key is the RTO Trade ID and Market Pair—only one scenario should exist for any given trade ID from one market to another. The summary columns includes a checkbox to be used for bulk deletion of scenarios, the RTO Trade ID, and the expected result of each of the steps of the RTO trade. The only filter is the Market Pair (a dropdown with a hard-coded list of available market pairs). The display also contains a toggle button that turns the simulation on or off and a button that serves as a link to the entry page to create new simulation scenarios.

The second display is the RTO Trade Simulator Scenario Entry. This display contains a dropdown to select the Market Pair, a text field for the RTO Trade ID, and a checkbox to indicate whether this scenario triggers the clearing event. It also contains a grid with each step for the currently selected market (not enterable), the time delay for each step (positive integer to be measured in seconds), and the simulated response. The simulated response is different for each step. The display also contains buttons for entry and deletion of the scenario. Validation is performed upon entry to ensure the uniqueness of the scenario based on the RTO Trade ID and the Market Pair. Multiple scenarios can have the trigger clearing flag set—the clearing will just happen multiple times in this case. The details for the response to each step are shown in Appendix 5, pages 1-3.

When the simulator is turned on, the main webAgent controller continues to operate as normal. However, when the time comes to submit a request to the market or issue a response to webTrader, the simulator will step in to provide the required action. For example, if the controller executes step 1 and the simulator scenario exists for the RTO Trade ID and has a value of “12345” and a delay of “20” for step 1, the simulator will return the appropriate message XML containing the RT Ramp Reservation ID of “12345” to the ramp submission subcall after 20 seconds.

For “Creation” and “Submission” type steps, the time delay value is used to implement the delay between the simulated submission to the market and the simulated market response. For “Confirmation” and “Clearing” steps, the delay is used as the amount of time to wait until the simulator should call the subcall to update the webTrader object.

Appendix 6 shows a detailed design of a PJM-NYISO trade with database schema. Appendix 7 shows a detailed design of a NYISO-ISONE trade with database schema. Appendix 8 shows a detailed design of a MISO-PJM trade with database schema. Appendix 9 shows a detailed design of an IESO-MISO trade with database schema. Appendix 10 shows a detailed design of a IESO-NYISO trade with database schema.

Appendix 11 shows design notes of trade voiding using webAgent.

Appendix 12 shows the design of the next iteration of the webAgent controller module.

Appendix 13 shows design notes on notification management in webAgent.

Appendix 14 shows design notes on modifying template fields in webAgent trade.

Appendix 15 shows a detailed design of RTO trade management in the IESO-NYISO pair.

The automation of the inter-RTO trading is only one example of the application of the webAgent technology. webAgent, however, can be utilized for other tasks that do not involve RTOs. Any manual gas or power trading or scheduling process that can be formally decomposed into a series of interdependent actions could be fully automated using webAgent. Every individual action will be defined as the webAgent execution step along with its data inputs and outputs that may include the creation of large or small objects, such as trades, schedules, reservations, tags, etc. The execution steps can then be combined into a sequence that would comprise the trade logic and could be executed by the webAgent controller upon request to perform all operations without human participation.

An example of how webAgent could be used to automate a complex process is the possible automation of a bilateral trade in electrical power. Such trade typically involves a purchase of power from one counterparty and its resale to another. In addition, a physical schedule to flow electricity from the point of receipt to the point of delivery must be created. The schedule's path can traverse various sections of the power grid facilitating the need to procure transmission rights from the transmission owners. This is accomplished by submitting requests for transmission services to OASIS nodes of the corresponding providers and securing their confirmation. Finally, the transaction is finalized by creating a NERC E-tag, submitting it to all parties (control areas, transmission providers, purchasing-selling entities, reliability authorities) and obtaining approval from all of them. Unless a tag is approved, a trade is not valid in compliance with the NERC “no tag, no schedule” policy.

This complex operation involves many interdependent actions that are performed in a specific order. These actions are performed manually and often by different people within the same company interfacing with different systems (trading software, scheduling system, OASIS portals, ETAG system) leading to inefficiencies and frequent errors caused by data re-entry.

The power trade described above can be modeled in webAgent by creating individual steps for each separate user action—trade entry, schedule creation, OASIS reservation submission, and tag creation. These steps are then combined into an execution sequence that establishes the data needs, inputs and outputs, and the inter-step logic (i.e. if OASIS reservation is approved, create and submit a NERC tag, etc.). Once the sequence is stored in webAgent, such trade can be executed multiple times without any user supervision in a fully automated fashion.

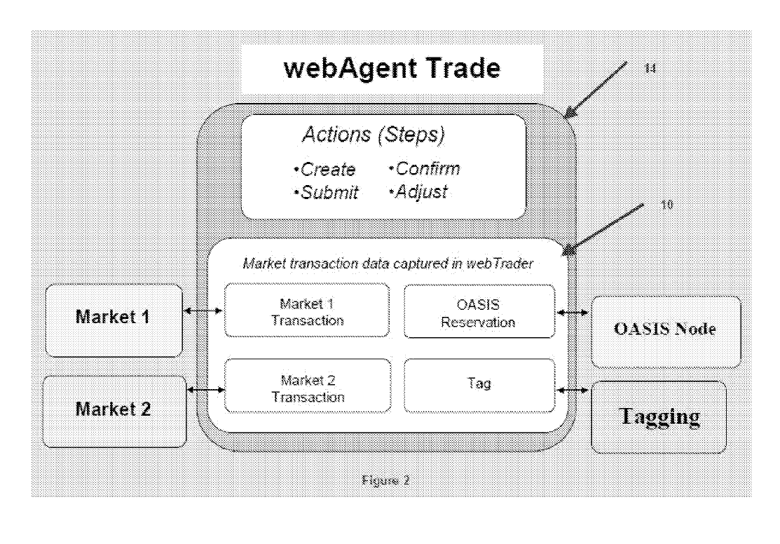

Referring now to FIGS. 1 and 2, block 10 refers to a user computer, which is running the webAgent software. The user computer is connected to the internet 12, which is also connected to the webAgent controller 14, which is the server which handles all webAgent trades.

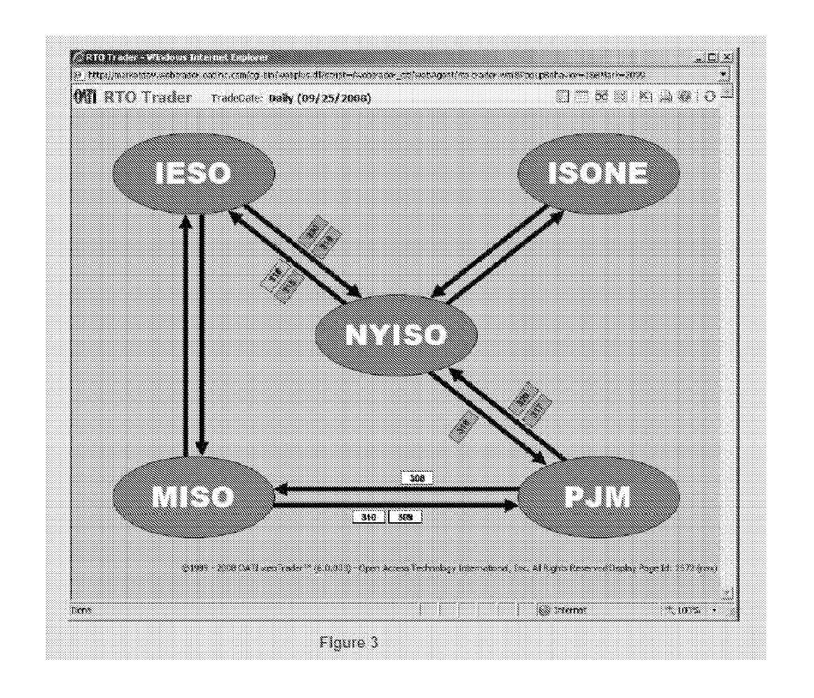

Referring now to FIG. 3, the various RTO's are shown, between which a user can purchase electricity in one RTO and sell electricity in another RTO.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

This completes the description of the preferred and alternate embodiments of the invention. Those skilled in the art may recognize other equivalents to the specific embodiment described herein which equivalents are intended to be encompassed by the claims attached hereto.

What is claimed is:

1. A computer program product for use with a graphics display device, the computer program product comprising:
a computer usable medium having computer readable program code means embodied in the medium for automating energy trading between regional transmission organizations (RTOs), the computer program product comprising:
computer readable program code means for creating a template for an energy trade between a first RTO and a second RTO, wherein the template comprises a plurality of trade components, the plurality of trade components being arranged in sequential order according to the first RTO and the second RTO's required order of execution;
computer readable program code means for selecting a template for an energy trade between two RTOs;
computer readable program code means for displaying a summary of a trade; and
computer readable program code means for monitoring and displaying a trade's status.

2. The computer program product of claim 1 further including data entry using a data entry device, for entering trade information such as the trade type.

3. The computer program product of claim 2 wherein the computer program allows a user to reconfigure a trade prior to execution.

4. The computer program product of claim 3 wherein the computer program allows the user to pause and/or resume a trade execution.

5. The computer program of claim 1 wherein a trade combines an execution sequence and data entry of data fields which contain all the necessary information to move power between two RTO's.

6. The computer program of claim 5 wherein a trade creates objects, such as a scheduling object, a tag object and/or a reservation object.

7. The computer program of claim 6 wherein the object data is controlled by a trade and a template.

8. The computer program of claim 7 wherein the created objects are captured in a software tool called webTrader.

9. The computer program of claim 8 wherein the templates provide a shortcut for trade entry.

10. The computer program of claim 1 further including a controller, which processes a plurality of trades in parallel.

11. The computer program of claim 10, in which the plurality of trades being processed by the controller can be at different stages of their trade lifespan.

12. The computer program of claim 10, in which the controller interprets the trade sequences of a trade, to process trade scheduling, trade data entry and/or trade notifications.

13. The computer program of claim 10 wherein the controller is configured as a persistent queue managing process.

14. The computer program of claim 13 wherein the controller simultaneously dispatches and manages execution of many steps in many trades in accordance with trade configuration as defined in respective trade sequences.

15. The computer program of claim 14 wherein the controller continuously scans the queue looking for processes that need to be executed.
